(19) United States
(12) Patent Application Publication
(10) Pub. No.: US 2022/0227585 A1
(43) Pub. Date: Jul. 21, 2022

(54) Multi-Directional Spiral Conveyor System

(71) Applicant: TREW, LLC, Fairfield, OH (US)

(72) Inventors: Nicolas T. Marois, Chandler, AZ (US); William E. Campbell, Logan, OH (US); Matthew J. Tefend, Columbus, OH (US)

(21) Appl. No.: 17/579,800

(22) Filed: Jan. 20, 2022

Related U.S. Application Data
(60) Provisional application No. 63/139,395, filed on Jan. 20, 2021.

(51) Int. Cl. B65G 13/08; B65G 13/11

(52) U.S. Cl. CPC B65G 13/08; B65G 2207/24; B65G 13/11

(57) ABSTRACT

A spiral conveyor system is provided to transport a plurality of articles thereon between at least one first level and at least one second level. The spiral conveyor system includes a conveyor assembly having more than one spiral conveyor. Each spiral conveyor defines a conveying surface for transporting the plurality of articles thereon. Each spiral conveyor is coupled with a support in a helical configuration such that each spiral conveyor is interleaved in an alternating configuration with another spiral conveyor about the support. Each conveying surface can selectively move in an inclining direction and in a declining direction such that the conveying surfaces can be moved simultaneously in the same or opposing directions.

### PRIORITY

This application claims the benefit of U.S. Pat. App. No. 63/139,395, entitled “Multi-Directional Spiral Conveyor System,” filed Jan. 20, 2021, the disclosure of which is incorporated by reference herein.

### BACKGROUND

The present disclosure relates generally to conveyors for transporting articles or packages, and is more particularly directed to spiral conveyors that convey articles or packages from one level (e.g. a first floor of a building) to another level (e.g., a second floor of the building). A spiral conveyor system typically comprises a generally vertical support extending between the levels (e.g., between the first and second floors of the building). A spiral conveyor is then typically wrapped about the support in a spiral configuration to define a conveying surface, for carrying the articles or packages thereon between the levels. Described herein are versions of multi-directional and/or multi-lane spiral conveyor systems to selectively convey articles or packages between levels.

### BRIEF DESCRIPTION OF THE DRAWINGS

The accompanying drawings illustrate embodiments which serve to explain the principles of the present innovation.

FIG. 1 is an isometric view of a portion of a first exemplary multi-directional spiral conveyor system.

FIG. 2 is a front view of the portion of the spiral conveyor system of FIG. 1.

FIG. 3 is a top plan view of the portion of the spiral conveyor system of FIG. 1.

FIG. 4 is a front view of a support of the spiral conveyor system of FIG. 1.

FIG. 5 is a top plan view of the support of FIG. 4.

FIG. 6 is a front view of a support section module of the support of FIG. 4.

FIG. 7 is a top plan view of the support section module of FIG. 6.

FIG. 8 is an enlarged partial perspective view of the encircled area of the support section module of FIG. 7 shown by circle 8 of FIG. 7.

FIG. 9 is an isometric view of a portion of a vertical support of the support section module of FIG. 6.

FIG. 10 is a front view of the portion of the vertical support of FIG. 9.

FIG. 11 is an isometric view of a horizontal support of the support section module of FIG. 6.

FIG. 12 is an exploded isometric view of an arm assembly of the support of FIG. 4.

FIG. 13 is a side elevational view of the arm assembly of FIG. 12.

FIG. 14 is an end view of the arm assembly of FIG. 12.

FIG. 15 is an enlarged partial front view of the arm assembly and the support of

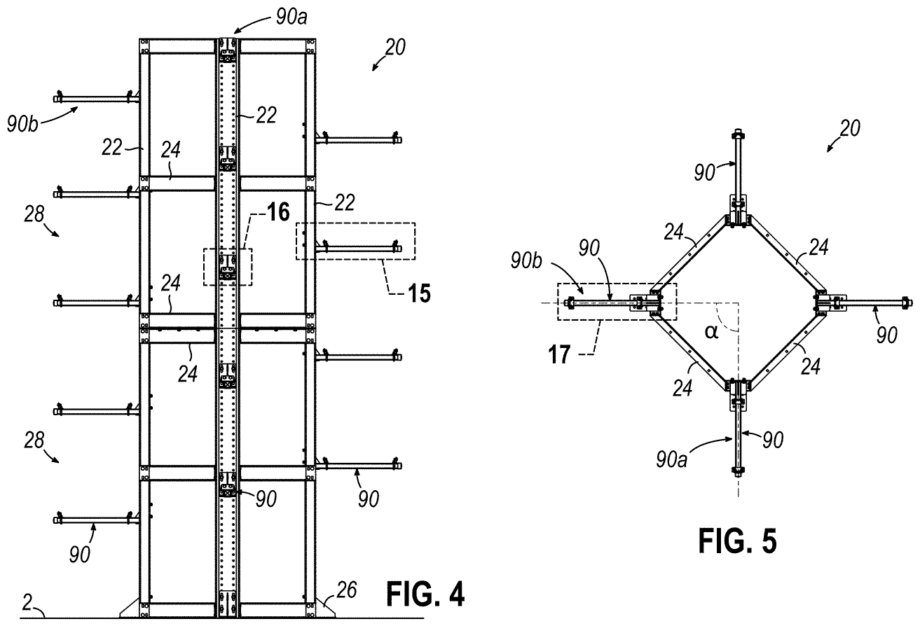

FIG. 4 shown by rectangle 15 of FIG. 4.

FIG. 16 is an enlarged partial end view of the arm assembly of the support of FIG. 4 shown by rectangle 16 of FIG. 4.

FIG. 17 is an enlarged partial top plan view of the arm assembly of the support of

FIG. 4 shown by rectangle 17 of FIG. 5.

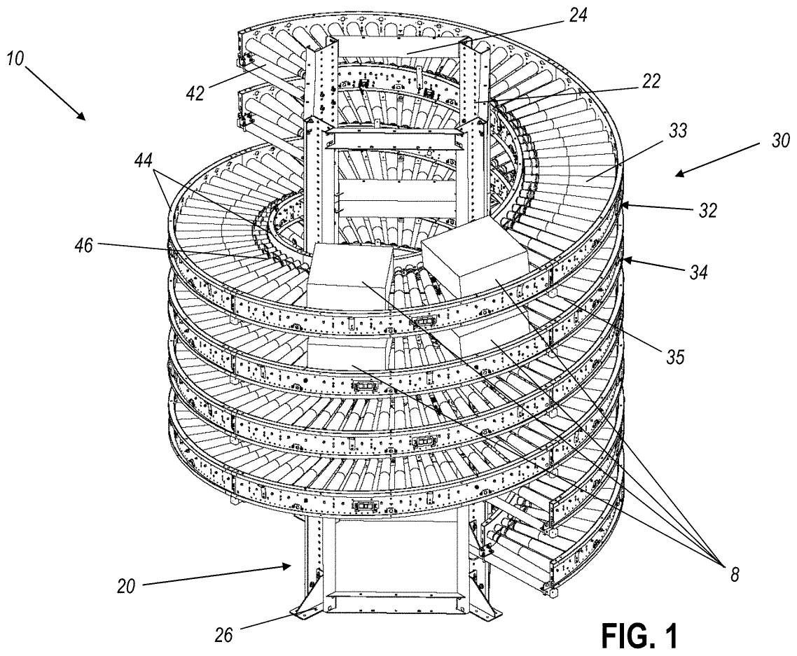

FIG. 18 is an enlarged partial top isometric view of a spiral conveyor of the portion of the spiral conveyor system of FIG. 1 coupled with the arm assembly.

FIG. 19 is an enlarged partial bottom isometric view of the spiral conveyor of

FIG. 18 with portions of the spiral conveyor shown in with a fainter line formatting for illustrative purposes.

FIG. 20 is an enlarged partial bottom plan view of the portion of the spiral conveyor of FIG. 1.

FIG. 21 is an enlarged partial side elevational view of the spiral conveyor of FIG. 20, with a portion of a side wall removed for illustrative purposes.

FIG. 22 is a top plan view of the portion of the spiral conveyor system of FIG. 1, showing tangential inputs of the first and second conveying surfaces and tangential outputs of the first and second conveying surfaces.

FIG. 23A is an isometric view of a portion of the portion of the spiral conveyor system of FIG. 1, showing a first conveying surface and a second conveying surface of the spiral conveyor system configured in a multi-lane configuration in a declining direction.

FIG. 23B is an isometric view of the portion of the spiral conveyor system of FIG. 23A, showing the first conveying surface and the second conveying surface of the spiral conveyor system configured in a multi-lane configuration in an inclining direction.

FIG. 23C is an isometric view of the portion of the spiral conveyor system of FIG. 23A, showing the first conveying surface and the second conveying surface of the spiral conveyor system configured in a multi-directional configuration with the first conveying system moving in the declining direction and the second conveying system moving in the inclining direction.

FIG. 23D is an isometric view of the portion of the spiral conveyor system of FIG. 23A, showing the first conveying surface and the second conveying surface of the spiral conveyor system configured in a multi-directional configuration with the first conveying system moving in the inclining direction and the second conveying system moving in the declining direction.

FIG. 24 is a partial isometric view of a conveyor system incorporating a plurality of the spiral conveyor systems of FIG. 1.

FIG. 25 is an elevational side view of a portion of a second exemplary multi-directional spiral conveyor system.

FIG. 26 is a top plan view of the portion of the spiral conveyor system of FIG. 25.

FIG. 27 is an isometric view of a portion of a third exemplary multi-directional spiral conveyor system.

FIG. 28 is a top plan view of a portion of the spiral conveyor system of FIG. 27 showing radial or perpendicular inputs and outputs on an inclining spiral configuration.

The drawings are not intended to be limiting in any way, and it is contemplated that various embodiments of the innovation may be carried out in a variety of other ways, including those not necessarily depicted in the drawings. The accompanying drawings incorporated in and forming a part of the specification illustrate several aspects of the present innovation, and together with the description serve to explain the principles of the innovation; it being understood, however, that this innovation is not limited to the precise arrangements shown.

### DETAILED DESCRIPTION

The following description of certain examples of the innovation should not be used to limit the scope of the present innovation. Other examples, features, aspects, embodiments, and advantages of the innovation will become apparent to those skilled in the art from the following description, which is by way of illustration, one of the best modes contemplated for carrying out the innovation. As will be realized, the innovation is capable of other different and obvious aspects, all without departing from the innovation. Accordingly, the drawings and descriptions should be regarded as illustrative in nature and not restrictive.

It is further understood that any one or more of the teachings, expressions, embodiments, examples, etc. described herein may be combined with any one or more of the other teachings, expressions, embodiments, examples, etc. that are described herein. The following described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

For clarity of disclosure, spatial terms such as “vertical,” “vertically,” “horizontal,” “horizontally,” “upward,” “upwardly,” “downward,” “downwardly,” “rear,” “side,” “top,” “bottom,” “inwardly,” “outwardly,” “outward,” “inclining,” “declining,” “lower,” “higher,” and “upper” also are used herein for reference to relative positions and directions. Such terms are used below with reference to views as illustrated for clarity and are not intended to limit the innovation described herein.

Furthermore, the terms “about,” “approximately,” and the like as used herein in connection with any numerical values or ranges of values are intended to encompass the exact value(s) referenced as well as a suitable tolerance that enables the referenced feature or combination of features to function for the intended purpose described herein.

The word “exemplary” is used herein to mean “serving as an example, instance, or illustration.” Any implementation described herein as “exemplary” is not necessarily to be construed as preferred or advantageous over other implementations.

A spiral conveyor system is configured to transport a plurality of articles thereon between at least one first level and at least one second level having a different elevation than that of the at least one first level. The spiral conveyor system comprises a support extending generally vertically from a position at or near the at least one first level to a position at or near the at least one second level and a conveyor assembly having more than one spiral conveyor coupled with the support. Each spiral conveyor defines a conveying surface configured to transport the plurality of articles thereon, wherein each spiral conveyor extends around the support in a generally helical configuration such that each spiral conveyor is interleaved in an alternating configuration with the other spiral conveyors about a longitudinal axis of the support from a respective first level to a respective second level. Each spiral conveyor may have a circular shape, an elliptical shape, or some other mix of straight and/or curved segmented configurations. In some versions, each spiral conveyor may have a substantially constant radius along the longitudinal axis. In other versions, each spiral conveyor may have a variable radius along the longitudinal axis. In addition, or alternatively, each spiral conveyor may have a substantially constant pitch measured parallel to the longitudinal axis. In other versions, each spiral conveyor may have a variable pitch measured parallel to the longitudinal axis.

Each conveying surface is configured to selectively move in an inclining direction and/or a declining direction between the respective levels. The spiral conveyor system is thereby configured to selectively operate in a multi-directional configuration and/or a multi-lane configuration. For instance, a first conveying surface is configured to transport a plurality of articles in an opposing inclining or declining direction from a second conveying surface when the spiral conveyor system is in the multi-directional configuration. Alternatively, the first conveying surface is configured to transport a plurality of articles in the same inclining or declining direction as the second conveying surface when the spiral conveyor system is in the multi-lane configuration.

Accordingly, the increased amount of the conveying surface area of the spiral conveyor system in the helical configuration provides an increased flow capability and/or functional capacity relative to a typical single lane spiral conveyor system. The additional conveying surfaces of the spiral conveyor system may also allow the spiral conveyor system to transport a plurality of articles between levels more efficiently while conserving, minimizing, and/or optimizing the amount of floor space occupied by the spiral conveyor system.

### I. A First Exemplary Multi-Directional Spiral Conveyor System

FIGS. 1-3 show a first exemplary multi-directional spiral conveyor system 10 configured to transport a plurality of articles 8 conveyed thereon between one of first levels 4 or 5 and a respective second level 6 or 7 having a different elevation than the respective first level 4 or 5. Spiral conveyor system 10 comprises a support 20 extending generally vertically between each first level 4, 5 and each respective second level 6, 7, and a conveyor assembly 30 coupled with support 20. More particularly, support 20 extends from a position at or below each first level 4, 5 to a position at or above each second level 6, 7. In the illustrated version, support 20 is designed such that the spiral conveyor portion revolves about a single longitudinal axis A. Conveyor assembly 30 comprises a first spiral conveyor 32 defining a first conveying surface 33 configured to transport a plurality of articles 8 thereon, and a second spiral conveyor 34 defining a second conveying surface 35 also configured to transport a plurality of articles 8 thereon. In the illustrated version, second conveying surface 35 is independently operable from first conveying surface 33. First and second spiral conveyors 32, 34 are positioned about support 20 in a double helical configuration such that first and second spiral conveyors 32, 34 are interleaved in an alternating configuration about longitudinal axis A of support 20. In the illustrated version, first spiral conveyor 32 extends from an output 37 at first level 5 to an input 36 at second level 7, and second spiral conveyor 34 extends from an output 39 at first level 4 to an input 38 at second level 6. More particularly, first level 5 of first spiral conveyor 32 is positioned at least slightly above first level 4 of second spiral conveyor 34, and second level 7 of first spiral conveyor 32 is positioned at least slightly above second level 6 of second spiral conveyor 34, such that first spiral conveyor 32 is positioned above second spiral conveyor 34. In some other versions, first levels 4, 5 may be positioned at a substantially same height as each other (e.g., by extending first spiral conveyor 32 further downwardly along its spiral path) and/or second levels 6, 7 may be positioned at a substantially same height as each other (e.g., by extending second spiral conveyor 34 further upwardly along its spiral path). In other versions, first level 5 of first spiral conveyor 32 may be positioned at least slightly below first level 4 of second spiral conveyor 34, and second level 7 of first spiral conveyor 32 may be positioned at least slightly below second level 6 of second spiral conveyor 34, such that first spiral conveyor 32 may be positioned below second spiral conveyor 34. While two levels 4, 5, 6, 7 are shown and described for each conveyor 32, 34, it should be understood that more levels may be employed for each conveyor 32, 34. For example, one or both conveyors 32, 34 may include one or more additional inputs and/or outputs at levels between the respective first and second levels 4, 5, 6, 7. It may also be understood that more than two conveyors 32, 34 may be employed in a triple, quadruple, or other configuration.

Each of first and second conveying surfaces 33, 35 of first and second spiral conveyors 32, 34 are configured to selectively move in an inclining direction to transport a plurality of articles 8 upward and/or a declining direction to transport a plurality of articles 8 downward. Accordingly, spiral conveyor system 10 is configured to operate in a selectable multi-directional and/or multi-lane configuration. For instance, first conveying surface 33 is configured to transport a plurality of articles 8 in an opposing direction from second conveying surface 35 in the selected one of the inclining and declining directions when spiral conveyor system 10 is in the multi-directional configuration. First conveying surface 33 is configured to transport a plurality of articles 8 in the same direction as second conveying surface 35 in the selected one of the inclining and declining directions when spiral conveyor system 10 is in the multi-lane configuration.

### A. An Exemplary Support

Support 20 of spiral conveyor system 10 is shown in more detail in FIGS. 4-7.

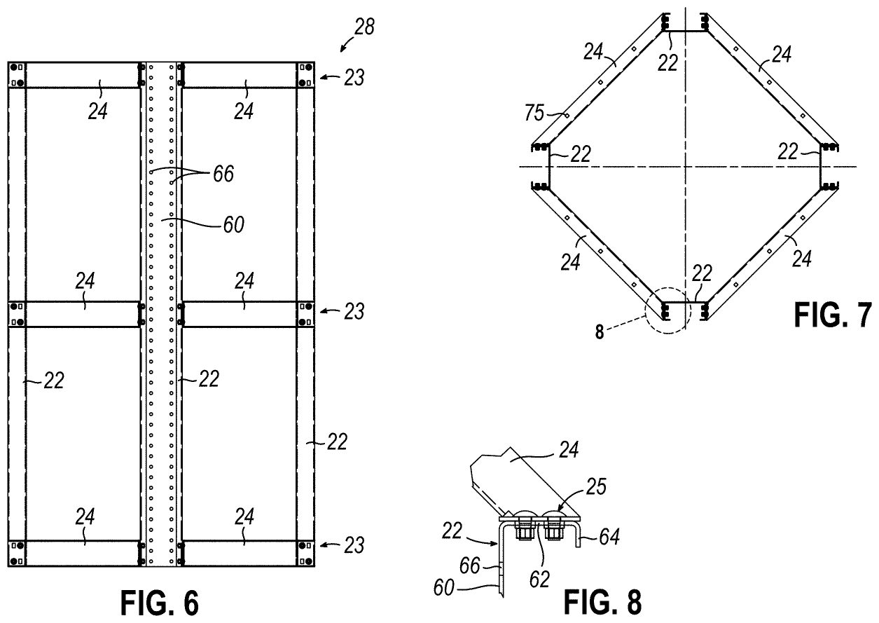

Support 20 comprises one or more support section modules 28 vertically aligned and coupled together at intersection 21 to form a desired height of support 20. While the illustrated version shows two support section modules 28, any other suitable number can be used. While this version shows a spiral conveyor having a circular shape, support 20 can be of any shape or configuration such that it supports the spiral conveyor system having a circular shape or any other suitable shape (e.g., elliptical, etc.). Referring to FIGS. 6-7, each support section module 28 comprises a plurality of vertical supports 22 and a plurality of horizontal supports 24 positioned between vertical supports 22. Vertical supports 22 extend generally vertically and are spaced apart from one another by horizontal supports 24. In the illustrated version, four vertical supports 22 are shown such that vertical supports 22 are equidistantly spaced apart about 90° relative to each other, though any other suitable number and/or spacing can be used. In some versions, support 20 may include a single, centrally positioned, vertical column support. Accordingly, support section module 28 of the illustrated version has a generally square cross-sectional profile, as shown in FIG. 7, but any other suitable profile can be used (e.g., triangular, pentagonal, hexagonal, octagonal, etc.) depending on the number of vertical supports 22 used. Horizontal supports 24 extend generally horizontally and are spaced apart from one another longitudinally along vertical supports 22. In the illustrated version, horizontal supports 24 are aligned in rows 23 between each vertical support 22 at a lower portion, a central portion, and an upper portion of each vertical support 22, as shown in FIG. 6, but other suitable configurations can be used.

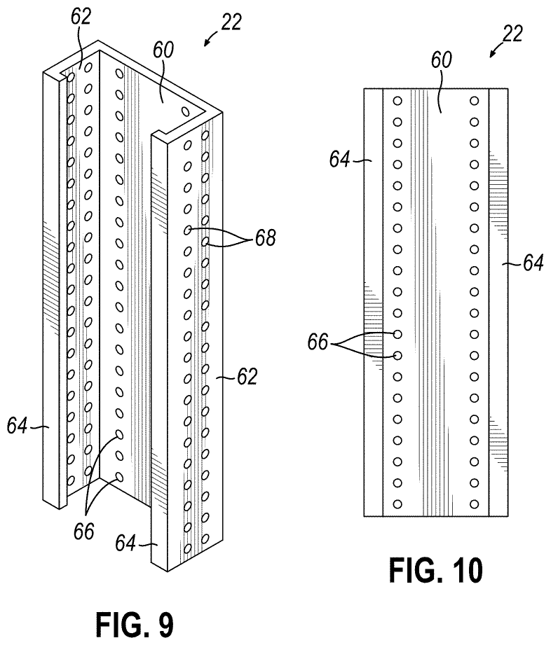

As shown in FIGS. 9-10, each vertical support 22 comprises a web 60, a pair of side walls 62 extending from opposite end portions of web 60, and a pair of flanges 64 extending inwardly from each side wall 62. Accordingly, vertical support 22 has a generally C-shaped profile, though other suitable configurations can be used. Each opposite end portion of web 60 of vertical support 22 includes a plurality of openings 66 extending through web 60. In the illustrated version, openings 66 are aligned generally longitudinally along each opposite end portion of web 60 adjacent to side walls 62. Each side wall 62 further includes a plurality of openings 68 extending through each side wall 62. In the illustrated version, openings 68 are aligned generally longitudinally along each side wall 62.

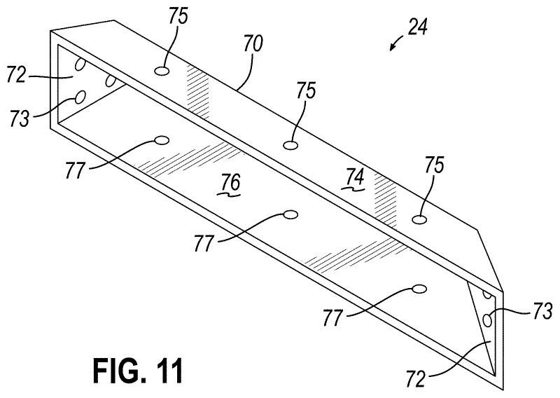

Referring to FIG. 11, each horizontal support 24 comprises a rear wall 70, a pair of side walls 72 extending outwardly from each opposite end portion of rear wall 70, a top wall 74 extending outwardly from a top portion of rear wall 70 between side walls 72, and a bottom wall 76 extending outwardly from a bottom portion of rear wall 70 between side walls 72. Each end portion of top and bottom walls 74, 76 of horizontal support 24 are tapered such that horizontal support 24 is longer in the front open portion of horizontal support 24 than at the closed rear wall 70 portion. In the illustrated version, the end portions of top and bottom walls 74, 76 extend outward at about 45° relative to rear wall 70, though other suitable dimensions can be used. For instance, the angle of top and bottom walls 74, 76 may change depending on the number of vertical supports 22 used to form a complementary angle with vertical supports 22. Top wall 74 of horizontal support 24 includes a plurality of openings 75 extending through top wall 74 and generally aligned longitudinally along a central portion of top wall 74. Bottom wall 76 also includes a plurality of openings 77 extending through bottom wall 76 and aligned generally longitudinally along a central portion of bottom wall 76. Each side wall 72 includes a plurality of openings 73 extending through side walls 72.

Referring back to FIGS. 7-8, side walls 62 of vertical support 22 are selectively couplable with side walls 72 of horizontal support 24. For instance, a side wall 72 of horizontal support 24 is aligned with a side wall 62 of vertical support 22 such that openings 73 of horizontal support 24 are aligned with openings 68 of vertical support 22. A fastener 25 (e.g., a bolt, a screw, a rivet, etc.) is then positioned through openings 68, 73 of vertical and horizontal supports 22, 24 to couple horizontal support 24 with vertical support 22. Additionally or alternatively, supports 22, 24 can be coupled by welding or any other suitable bonding technique (e.g., glue, clamps, etc.). Because each side wall 62 of vertical support 22 includes a plurality of openings 68, horizontal support 24 is configured to be selectively coupled to vertical support 22 at a desired height. Accordingly, the position of horizontal support 24 can also be adjusted along the length of vertical support 22. In the illustrated version, horizontal supports 24 are coupled with vertical supports 22 such that horizontal supports 24 are aligned with each other in a plurality of rows 23. In some other versions, horizontal supports 24 are offset relative to each other.

Referring back to FIG. 4, support section modules 28 of support 20 can be selectively coupled together by aligning bottom walls 76 of horizontal supports 24 of one support section module 28 with top walls 74 of horizontal supports 24 of another support section module 28, as shown at intersection 21. This may align openings 75, 77 of horizontal supports 24 such that fasteners (e.g., screws, bolts, rivets, etc.), may be inserted through openings 75, 77 to secure support section modules 28 together. Additionally or alternatively, support section modules 28 can be coupled by welding or any other suitable bonding technique (e.g., glue, clamps, etc.). A base support 26 can then be coupled to one or more vertical supports 22 at a bottom portion of support section module 28 such that base support 26 provides additional support by anchoring support 20 to a floor surface 2.

Support 20 further comprises a plurality of arm assemblies 90 extending outward from each vertical support 22 in a cantilever configuration. Arm assemblies 90 are thereby configured to support conveyor assembly 30. As best seen in FIGS. 4-5, arm assemblies 90 are longitudinally and rotationally offset relative to each other about support 20. For instance, a first arm assembly 90a is positioned on a first vertical support 22, and an adjacent second arm assembly 90b is positioned clockwise or counterclockwise on the next adjacent vertical support 22 at an angle a such that the adjacent second arm assembly 90b is rotationally offset from the first arm assembly 90a about a longitudinal axis of support 20. In the illustrated version, adjacent arm assemblies 90a, 90b are rotationally offset about 90 degrees relative to each other, but any other suitable angles can be used. Additionally or alternatively, adjacent second arm assembly 90b is longitudinally offset relative to first arm assembly 90a along support 20 such that adjacent second arm assembly 90b is spaced a distance d relative to first arm assembly 90a. Adjacent arm assemblies 90a, 90b may be longitudinally offset relative to each other from about 6 inches to about 12 inches, such as about 9 inches, though other suitable dimensions can be used. This may allow for about 24 inches to about 48 inches, such as about 36 inches, of elevation change for one revolution about each spiral conveyor 32, 34. Still other suitable dimensions can be used. This may allow each spiral conveyor 32, 34 of conveyor assembly 30 to form a helical configuration about support 20.

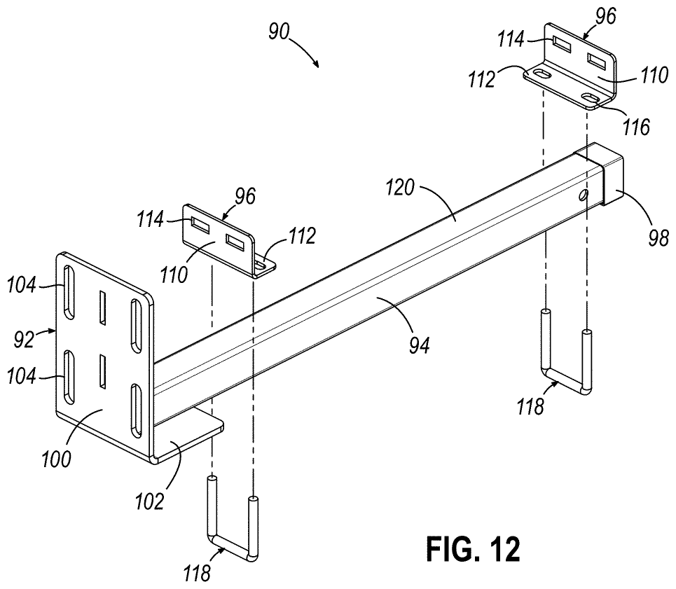

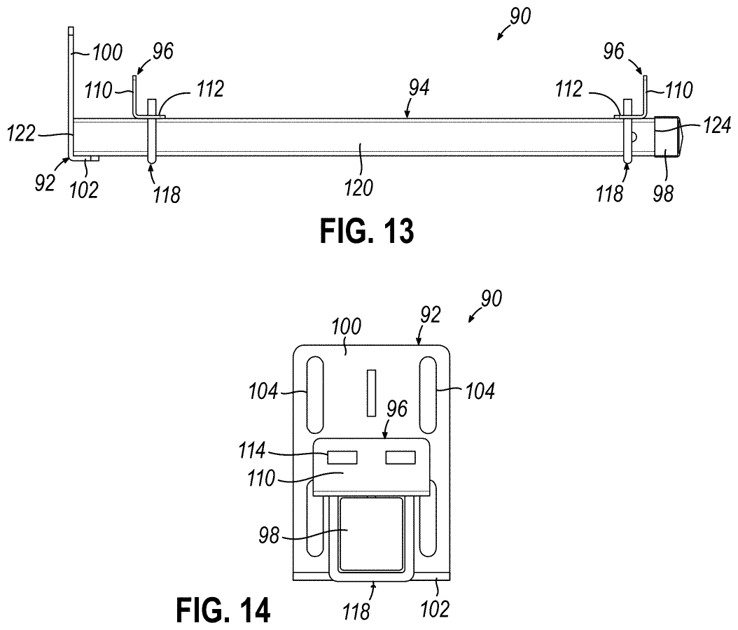

FIGS. 12-14 show arm assembly 90 in more detail. Each arm assembly 90 comprises an arm 94, an arm support 92, and a pair of conveyor supports 96. Arm 94 includes a body 120 extending between a first end 122 and a second end 124. First end 122 is coupled with arm support 92 such that body 120 extends outwardly from arm support 92 to a free, second end 124, which may be covered by a cap 98. Arm support 92 includes an upright portion 100 and a lateral portion 102 extending outward from upright portion 100 to form a generally L-shaped bracket, though other suitable configurations may be used. Accordingly, first end 122 of arm 94 can be positioned against upright portion 100 and lateral portion 102 of arm support 92. In some versions, arm 94 can be coupled with arm support 92 such as by welding and/or fasteners (e.g., a bolt, a screw, a rivet, etc.). Upright portion 100 of arm support 92 further includes a plurality of openings 104 extending through upright portion 100.

Each conveyor support 96 comprises an upright portion 110 and a lateral portion 112 extending outward from upright portion 110 to form a generally L-shaped bracket, though other suitable configurations may be used. Each portion 110, 112 includes openings 114, 116 extending through each corresponding portion 110, 112. Conveyor support 96 further includes brackets 118 having a generally U-shaped configuration. Accordingly, lateral portions 112 of each conveyor support 96 can be positioned on a top surface of arm 94 and each bracket 118 can be positioned underneath arm 94 and inserted through openings 116 of conveyor support 96 to maintain the position of conveyor support 96 relative to arm 94.

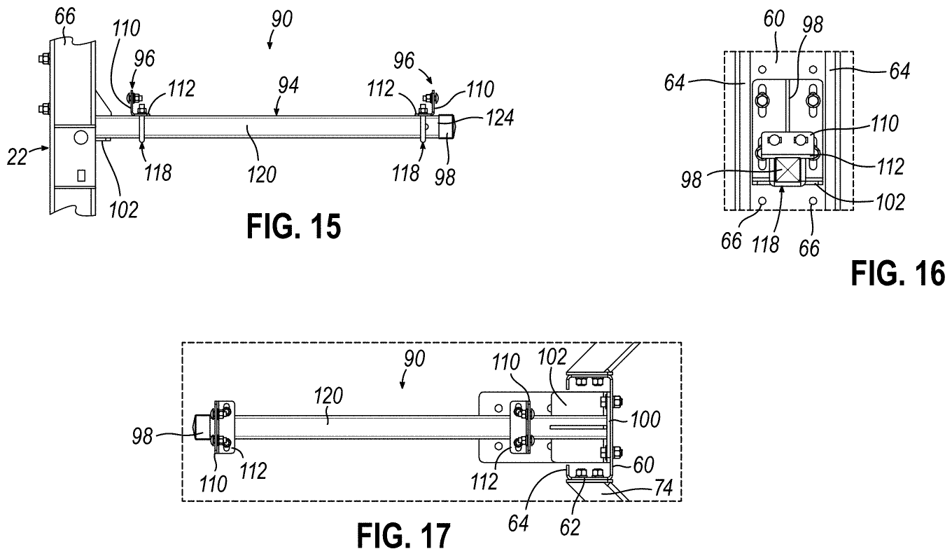

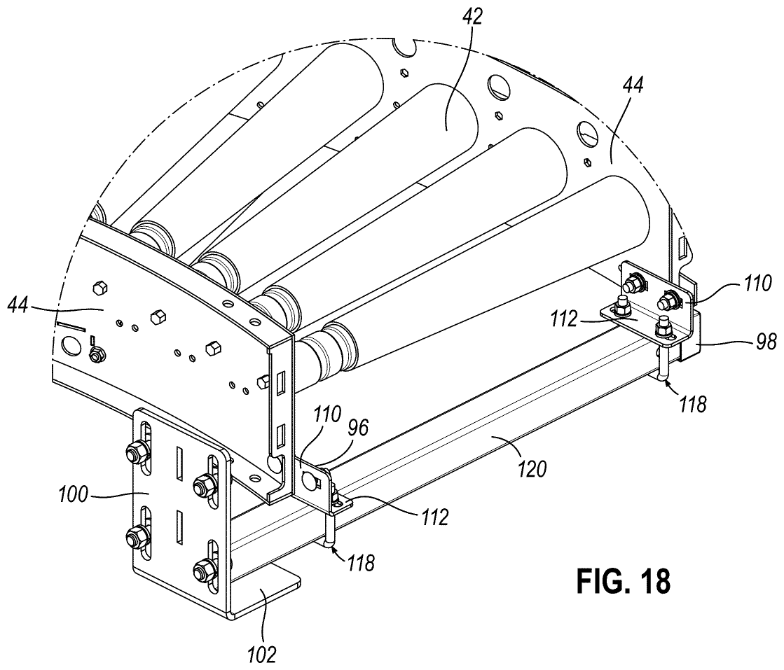

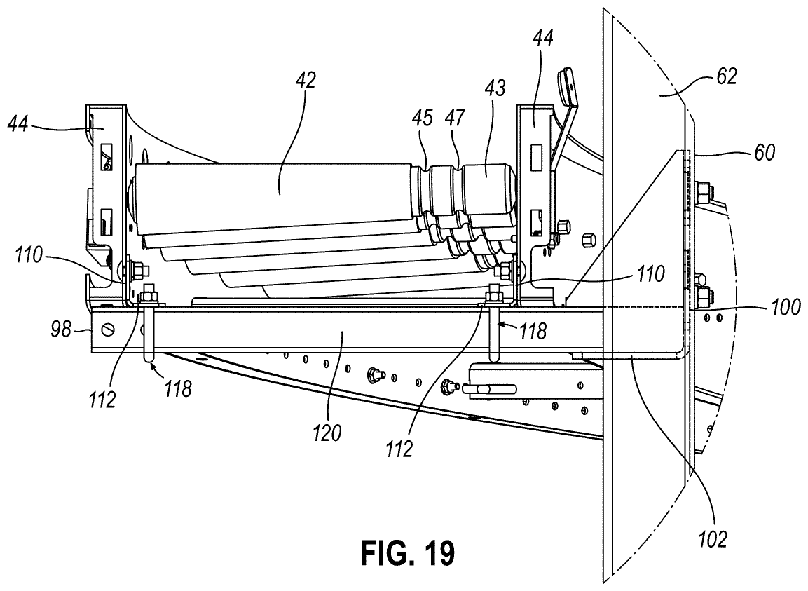

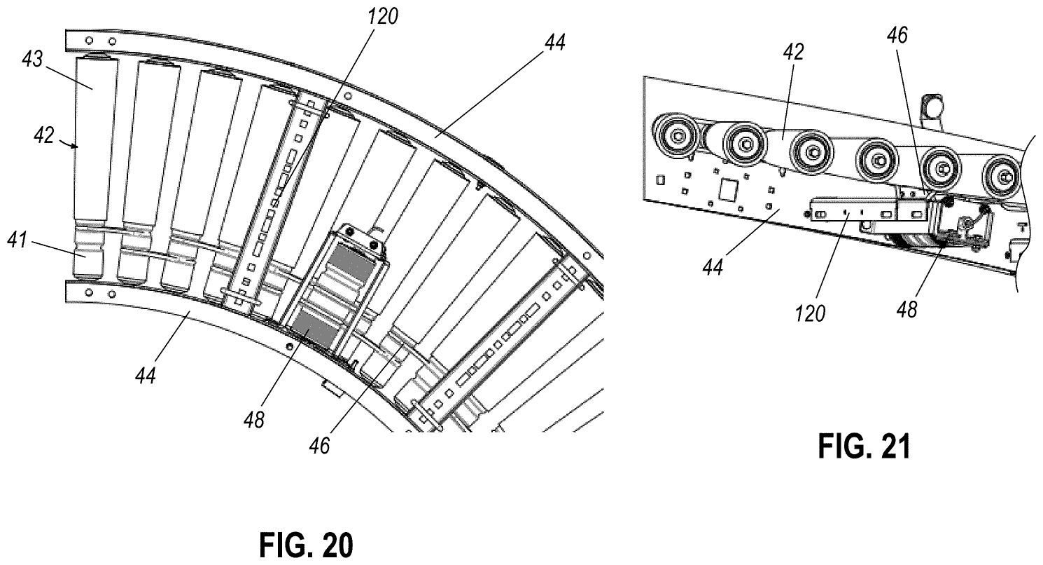

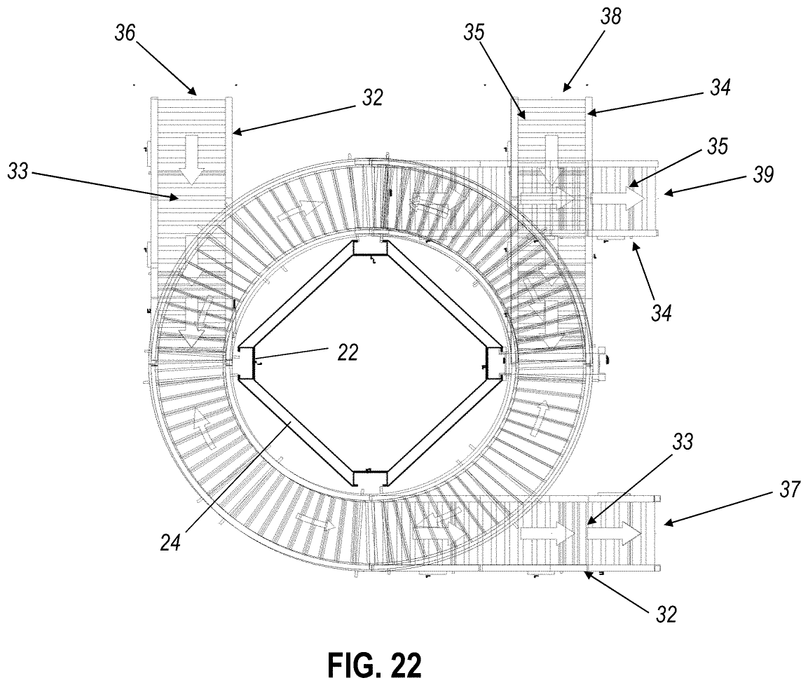

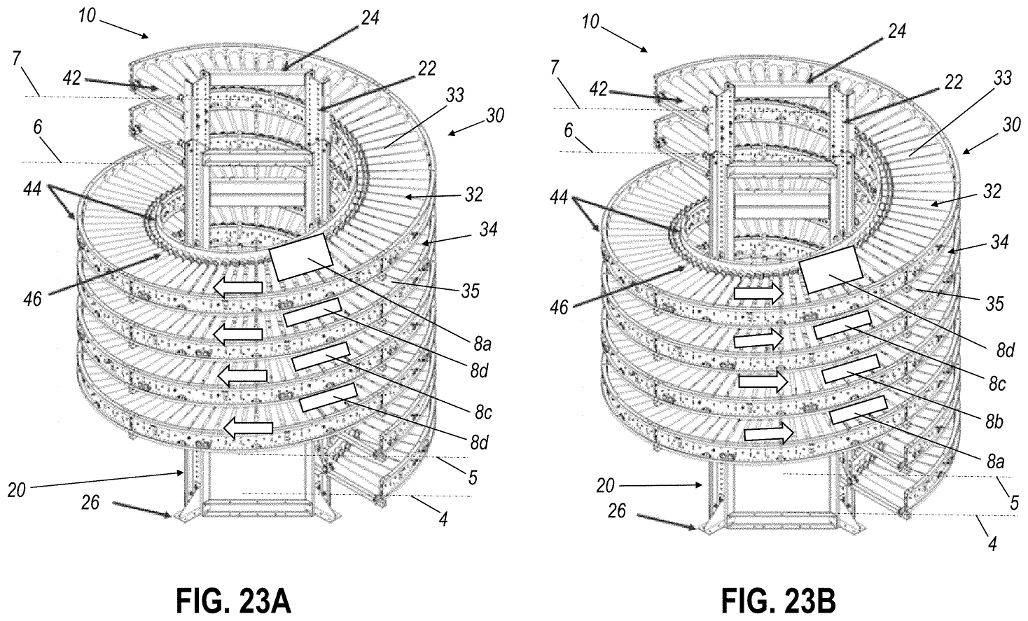

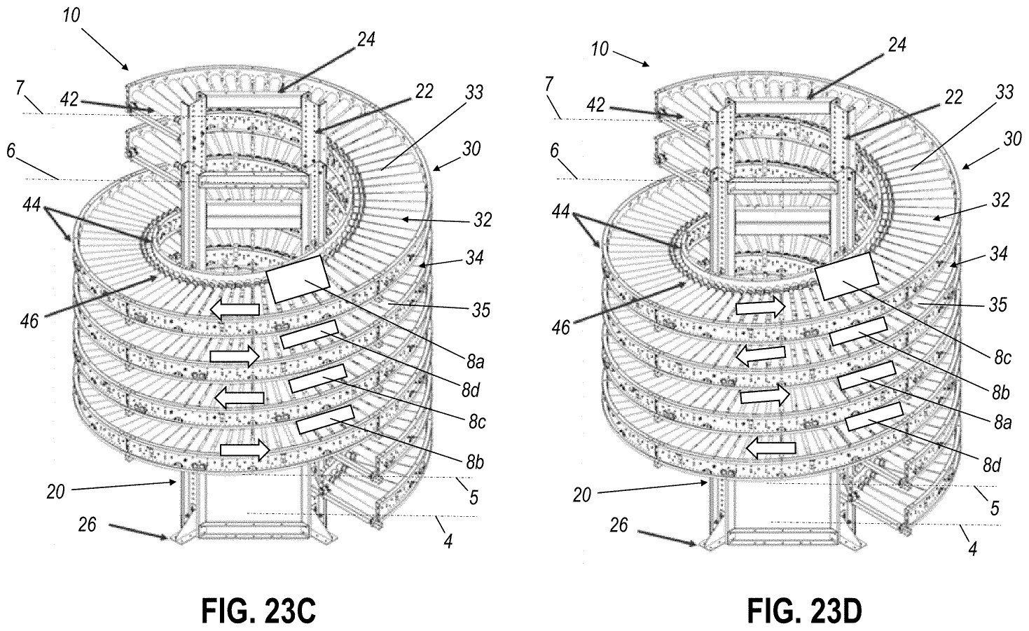

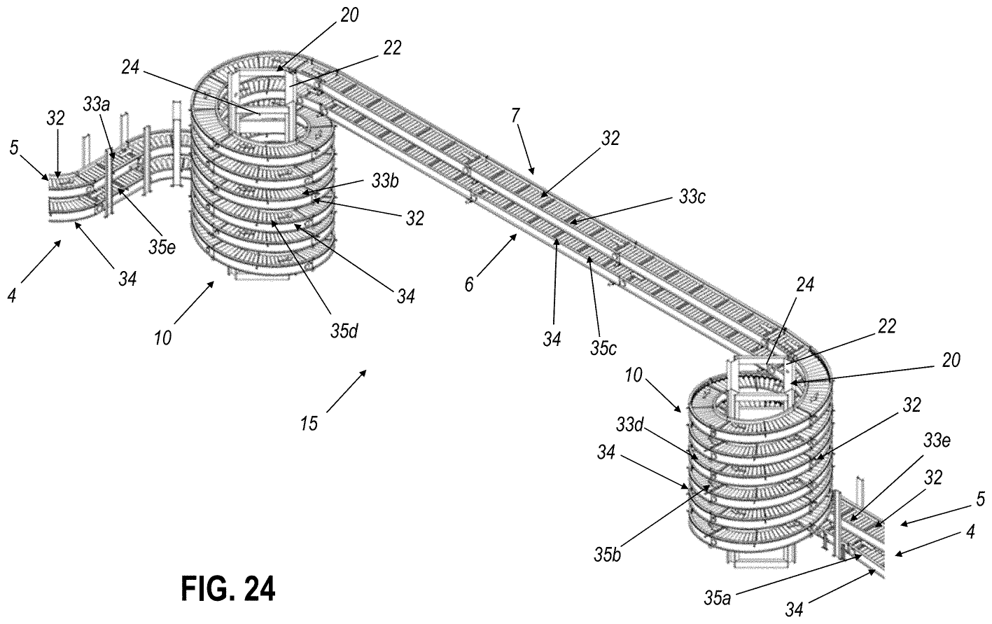

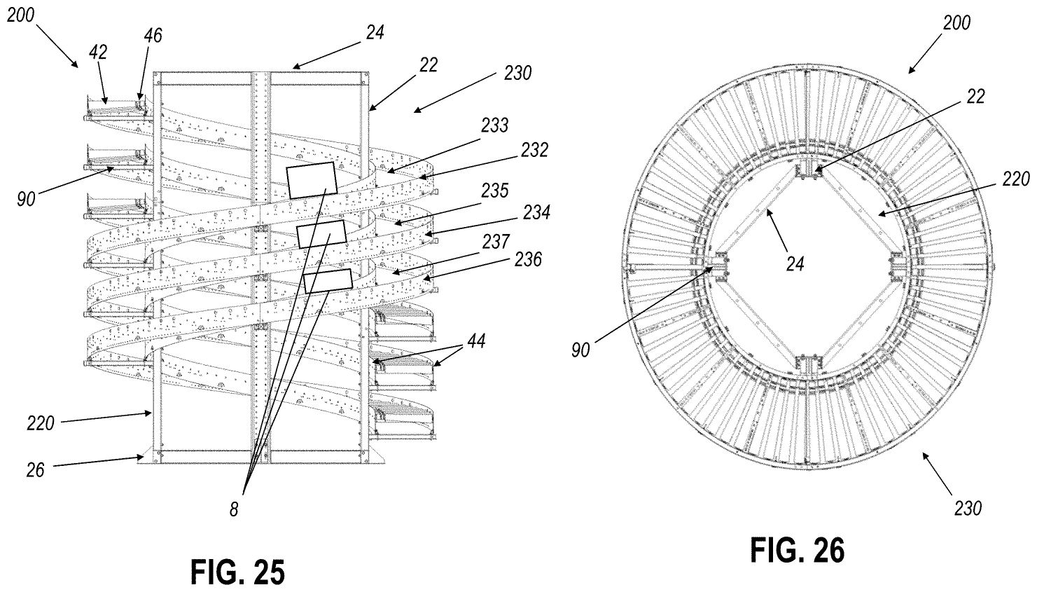

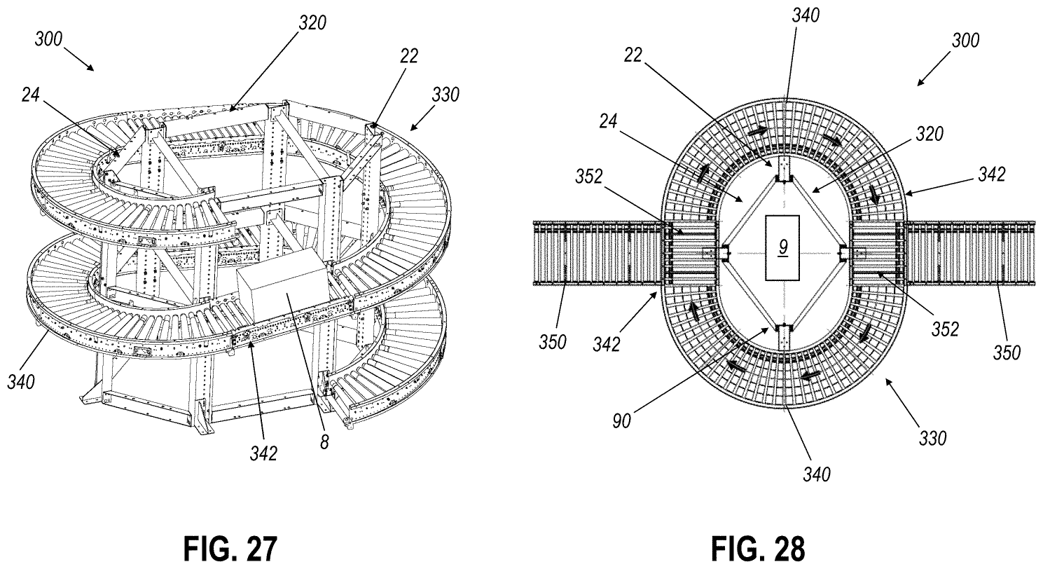

Referring to FIGS. 15-17, each arm assembly 90 can be selectively coupled to support 20 at a desired height, which can be adjusted. For instance, upright portion 100 of arm support 92 is positioned against web 60 of a vertical support 22 to align openings 104 of arm support 92 with openings 66 of vertical support 22 at a desired height. In the illustrated version, openings 104 of arm support 92 are configured as slots having a length along upright portion 100 of arm support 92. Accordingly, the position of upright portion 100 may be adjusted along each slot 104 relative to an opening 66 of web 60 to provide further adjustment of arm support 92 along vertical support 22 between openings 66. Fasteners may then be inserted through openings 66, 104 to couple arm support 92 with vertical support 22. Additionally or alternatively, arm support 92 may be welded to vertical support 22. Conveyor assembly 30 may then be coupled with conveyor supports 96, as will be discussed in more detail below. Still other suitable configurations for support 20 will be apparent to one with ordinary skill in the art in view of the teachings herein.

### B. An Exemplary Conveyor Assembly

Referring back to FIGS. 1-3, conveyor assembly 30 comprises a first spiral conveyor 32 and a second spiral conveyor 34. Each conveyor 32, 34 comprises a pair of side walls 44 and a plurality of rollers 42 extending between side walls 44 that are rotatable relative to side walls 44. The plurality of rollers 42 of first spiral conveyor 32 define a first conveying surface 33 extending along first spiral conveyor 32 configured to transport articles 8 thereon. The plurality of rollers 42 of second spiral conveyor 34 define a second conveying surface 35 extending along second spiral conveyor 34 that is independently operable from first conveying surface 33, which is also configured to transport articles 8 thereon.

Side walls 44 of each conveyor 32, 34 are coupled with conveyor supports 96 of support 20, as shown in FIGS. 18-19. For instance, an interior surface of each side wall 44 may be aligned with an exterior surface of each upright portion 110 of a corresponding conveyor support 96. A bottom surface of each side wall 44 may rest on arm 94 to support side walls 44. Each side wall 44 may further include openings that align with openings 114 of conveyor support 96 such that fasteners may be inserted through openings 114 to secure side walls 44 with conveyor supports 96. Additionally or alternatively, side walls 44 may be welded with conveyor supports 96.

As shown in FIGS. 18-19, each roller 42 is tapered from a first end 41 to a second end 43 such that roller 42 narrows from first end 41 to second end 43. Accordingly, rollers 42 widen as rollers 42 extend outwardly from support 20. This may accommodate the spiral configuration of first and second spiral conveyors 32, 34 to provide a substantially continuous conveying surface 33, 35. Rollers 42 further include a pair of grooves 45, 47 for receiving an O-band 46 therein. In the illustrated version, grooves 45, 47 are positioned near second end 43 at a narrower portion of roller 42. Rollers 42 of the illustrated version are typically powered in zones by using interconnecting O-bands 46 in conjunction with a single electric or electromagnetic motor 48, which rests below the driven rollers 42. Motor 48 may comprise an external rotor gearless motor as shown in U.S. Pat. No. 10,093,487, for example. Motor(s) 48 can be controlled such that the drive rotation can spin in the appropriate product flow direction, such as the inclining and/or declining directions. For instance, as shown in FIGS. 20-21, an O-band 46 is coupled with motor 48 and at least one roller 42. In some versions, an O-band 46 is coupled with two rollers 42. A plurality of O-bands 46 are then interconnected between rollers 42, within grooves 45, 47, to operationally couple the plurality of rollers 42 with motor 48. Accordingly, when motor 48 is actuated, motor 48 rotates to thereby rotate the plurality of rollers 42 via O-bands 46. Motor 48 is configured to rotate rollers 42 in both an inclining and declining direction. In some versions, motorized drive roller (MDR) conveyors may define portions or all of conveying surfaces 33 and 34.

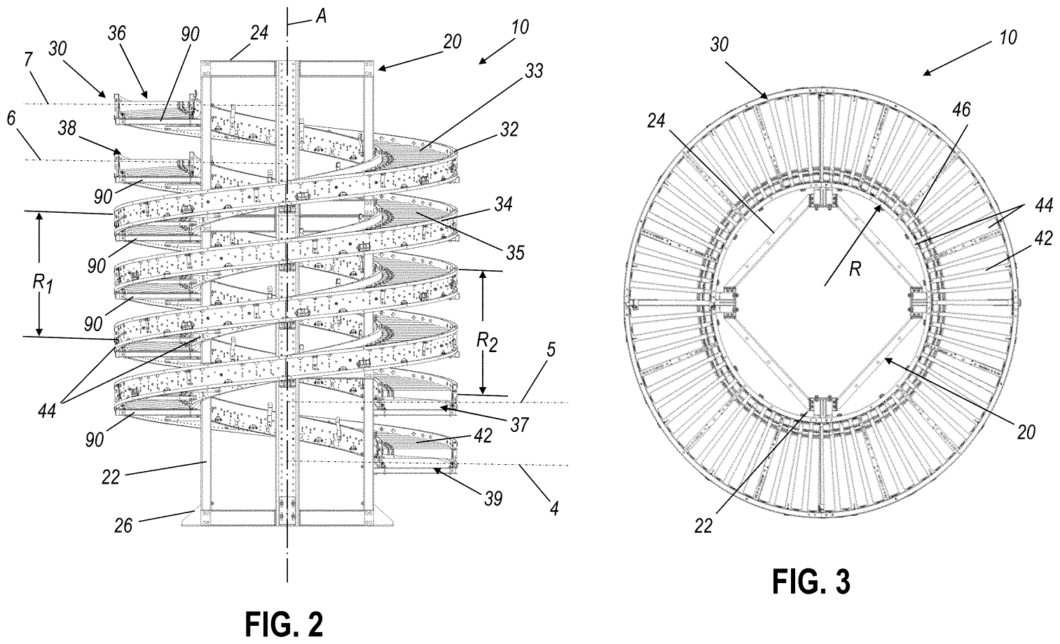

Referring back to FIGS. 1-3, each of first and second spiral conveyors 32, 34 are generally curved in a spiral such that first and second spiral conveyors 32, 34 are positioned in a helical configuration about support 20. In the illustrated version, first and second spiral conveyors 32, 34 are concentrically aligned with each other and are interleaved in an alternating configuration to form a double helical configuration about longitudinal axis A of support 20. First and second spiral conveyors 32, 34 are shown having a circular profile, as shown in FIG. 3, but any other suitable profile shape can be used (e.g., oval, elliptical, square, rectangular, etc.). As best shown in FIG. 2, first spiral conveyor 32 defines a first rise R₁ that corresponds to the change in elevation of one revolution of first spiral conveyor 32 about support 20. In the illustrated version, first rise R₁ is from about 24 inches to about 48 inches, such as about 36 inches, though other suitable dimensions can be used. Second spiral conveyor 34 defines a second rise R₂ that corresponds to the change in elevation of one revolution of second spiral conveyor 34 about support 20. Second rise R₂ can be the same or different than first rise In the illustrated version, second rise R₂ is substantially equal to first rise Second rise R₂ can be from about 24 inches to about 48 inches, such as about 36 inches, though other suitable dimensions can be used.

In some versions, rise R₁, R₂ of first and second spiral conveyors 32, 34 can be increased and/or decreased. As rise R₁, R₂ increases and/or decreases, an inner radius R of first and second spiral conveyors 32, 34 correspondingly increases and/or decreases to substantially maintain a desired angle of inclination. For instance, a rise R₁, R₂ of about 36 inches may correspond to an inner radius R of first and second spiral conveyors 32, 34 of about 32½ inches. An increase and/or decrease in rise R₁, R₂ of first and second spiral conveyors 32, 34 of about 12 inches may correspond to an increase and/or decrease in inner radius R of first and second spiral conveyors 32, 34 of about 15 inches, though other suitable dimensions can be used.

Because of the spiral configuration of first and second spiral conveyors 32, 34, each conveying surface 33, 35 can be configured to start and/or terminate at any desired elevation and/or angular direction about longitudinal axis A of support 20. For instance, as shown in FIGS. 1 and 22, first conveying surface 33 of first spiral conveyor 32 has an input 36 from which an article may enter first conveying surface 33. First conveying surface 33 also has an output 37 from which an article may exit first conveying surface 33. Likewise, second conveying surface 35 of second spiral conveyor 34 has an input 38, from which an article may enter second conveying surface 35, and an output 39, from which an article may exit second conveying surface 35. Input 36, 38 of each first and second spiral conveyors 32, 34 may begin at a select elevation at any angular direction (e.g., from about 0 degrees to about 360 degrees) relative to longitudinal axis A. Output 37, 39 of each first and second spiral conveyors 32, 34 may also end at a select elevation at any angular direction (e.g., from about 0 degrees to about 360 degrees) relative to longitudinal axis A. Accordingly, each of inputs 36, 38 and/or outputs 37, 39 of first and second spiral conveyors 32, 34 may have the same and/or different angular directions and/or elevations.

For instance, as illustrated in FIG. 22, first conveying surface 33 has an input 36 located at first level 5 and oriented tangentially relative to the spiral path of first conveying surface 33 at or near a 9 o'clock position in the frame of reference provided by FIG. 22. First conveying surface 33 extends upwardly about support 20 in a counterclockwise direction in the frame of reference provided by FIG. 22 and has an output 37 located at second level 7 and oriented tangentially relative to the spiral path of first conveying surface 33 at or near a 6 o'clock position in the frame of reference provided by FIG. 22, such that output 37 is oriented at about 90 degrees relative to input 36. Second conveying surface 35 has an input 38 located at second level 6 and oriented tangentially relative to the spiral path of second conveying surface 35 at or near a 3 o'clock position in the frame of reference provided by FIG. 22. Second conveying surface 35 extends downwardly about support 20 in a clockwise direction in the frame of reference provided by FIG. 22 and has an output 39 located at first level 4 and oriented tangentially relative to the spiral path of second conveying surface 35 at or near a 12 o'clock position in the frame of reference provided by FIG. 22, such that output 39 is oriented at about 90 degrees relative to input 38. While the illustrated version shows each of first and second spiral conveyors 32, 34 having a single input 36, 38 and output 37, 39, each of first and second spiral conveyors 32, 34 can have a plurality of inputs 36, 38 and/or outputs 37, 39. Still other suitable configurations for conveyor assembly 30 will be apparent to one with ordinary skill in the art in view of the teachings herein. For example, while tangential inputs 36, 38 and outputs 37, 39 are shown, any one or more of inputs 36, 38 and/or outputs 37, 39 may be oriented non-tangentially relative to the spiral path of the respective conveying surface 33, 35, such as obliquely relative to the spiral path of the respective conveying surface 33, 35, or perpendicularly relative to the spiral path of the respective conveying surface 33, 35 in a manner similar to that shown in FIG. 28.

### II. Exemplary Methods of Conveying

As discussed above, spiral conveyor system 10 is configured to transport articles 8 between at least one first level 4, 5 and at least one second level 6, 7 that is positioned at a different elevation than the at least one first level 4, 5. In some versions, spiral conveyor system 10 is configured to transport articles 8 to additional levels above and/or below levels 4, 5, 6, 7. Each of first and second spiral conveyors 32, 34 are configured to be selectively operated in an inclining and/or declining direction. First spiral conveyor 32 can be operated in the same and/or opposite inclining and declining direction as second spiral conveyor 34. When first and second spiral conveyors 32, 34 are operated in the same direction, spiral conveyor system 10 is thereby operated in a multi-lane configuration such that each conveying surface 33, 35 of first and second spiral conveyors 32, 34 defines a lane that are both moving in the same select inclining or declining direction (e.g., both conveying surfaces 33, 35 are moving in the inclining direction or both conveying surfaces 33, 35 are moving in the declining direction). When first and second spiral conveyors 32, 34 are moving in opposing directions, spiral conveyor system 10 is thereby operated in a multi-directional configuration (e.g., first conveying surface 33 is moving in the inclining direction while second conveying surface 35 is moving in the declining direction or first conveying surface 33 is moving in the declining direction while second conveying surface 35 is moving in the inclining direction).

For instance, FIG. 23A shows first and second spiral conveyors 32, 34 moving simultaneously in a declining direction such that spiral conveyor system 10 is configured in a multi-lane declining configuration. As shown, first conveying surface 33 of first spiral conveyor 32 is moving in the declining direction such that an article 8a being transported thereon moves downward from an upper elevation at or near second level 7 to a lower elevation at or near first level 5, as shown by article 8c. Similarly, second conveying surface 35 of second spiral conveyor 34 is moving in the declining direction such that an article 8b being transported thereon moves downward from an upper elevation at or near second level 6 to a lower elevation at or near first level 4, as shown by article 8d.

FIG. 23B shows first and second spiral conveyors 32, 34 moving simultaneously in an inclining direction such that spiral conveyor system 10 is configured in a multi-lane inclining configuration. As shown, first conveying surface 33 of first spiral conveyor 32 is moving in the inclining direction such that an article 8b being transported thereon moves upward from a lower elevation at or near first level 5 to a higher elevation at or near second level 7, as shown by article 8d. Similarly, second conveying surface 35 of second spiral conveyor 34 is moving in the inclining direction such that an article 8a being transported thereon moves upward from a lower elevation at or near first level 4 to a higher elevation at or near second level 6, as shown by article 8c.

FIG. 23C shows first and second spiral conveyors 32, 34 moving simultaneously in opposing directions such that spiral conveyor system 10 is configured in a first multi-directional configuration. As shown, first conveying surface 33 of first spiral conveyor 32 is moving in the declining direction such that an article 8a being transported thereon moves downward from an upper elevation at or near second level 7 to a lower elevation at or near first level 5, as shown by article 8c. Meanwhile, second conveying surface 35 of second spiral conveyor 34 is moving in the inclining direction such that an article 8b being transported thereon moves upward from a lower elevation at or near first level 4 to a higher elevation at or near second level 6, as shown by article 8d.

FIG. 23D also shows first and second spiral conveyors 32, 34 moving simultaneously in opposing directions such that spiral conveyor system 10 is configured in a second multi-directional configuration. As shown, first conveying surface 33 of first spiral conveyor 32 is moving in the inclining direction such that an article 8a being transported thereon moves upward from a lower elevation at or near first level 5 to a higher elevation at or near second level 7, as shown by article 8c. Meanwhile, second conveying surface 35 of second spiral conveyor 34 is moving in the declining direction such that an article 8b being transported thereon moves downward from an upper elevation at or near second level 6 to a lower elevation at or near first level 4, as shown by article 8d. Still other methods for operating spiral conveyor system 10 will be apparent to one with ordinary skill in the art in view of the teachings herein.

In some versions, first and second spiral conveyors 32, 34 are configured to operate in a variety of modes. For instance, first and second spiral conveyors 32, 34 can be configured to operate in a transportation mode where the plurality of articles 8 move sequentially and simultaneously along a respective first and second conveying surface 33, 35 of first and second spiral conveyors 32, 34 to thereby transport the plurality of articles 8. First and second spiral conveyors 32, 34 can also be configured to operate in an accumulation or storage mode where first and second conveying surfaces 33, 35 are moved in a first direction to load a plurality of articles 8 onto one or both of first and second conveying surfaces 33, 35 to thereby store the plurality of articles 8 on the one or both of first and second conveying surfaces 33, 35. First and second conveying surfaces 33, 35 can then be moved to continue in the first direction and/or in an opposing second direction to unload the plurality of articles 8 from the one or both of the first and second conveying surfaces 33, 35. Moreover, first and second spiral conveyors 32, 34 can be configured to operate in a recirculation mode such that the plurality of articles 8 can be unloaded and then reloaded onto one or both of first and second conveying surfaces 33, 35. In some versions, first and second conveyors 32, 34 are simultaneously operated in the same mode (e.g., transportation, accumulation, storage, and/or recirculation mode). In some other versions, first and second conveyors 32, 34 are simultaneously operated in differing modes (e.g., transportation, accumulation, storage, and/or recirculation modes).

In some versions, a plurality of spiral conveyor systems 10 may be used to transport a plurality of articles 8 to a variety of levels 4, 5, 6, 7. FIG. 24 shows a conveyor system 15 incorporating two spiral conveyor systems 10, though any suitable number of spiral conveyor systems 10 can be used. In the illustrated version, first spiral conveyor 32 has a first conveying surface input, shown as 33a, at first level 5. First spiral conveyor 32 then extends about support 20 of a first spiral conveyor system 10 such that first conveying surface is configured to move upwardly on first spiral conveyor system 10, as shown by 33b, to second level 7. First conveying surface then extends along second level 7, as shown by 33c. First spiral conveyor 32 then extends about support 20 of a second spiral conveyor system 10 such that first conveying surface is configured to move downwardly on second spiral conveyor system 10, as shown by 33d, to return to first level 5. An output of first conveying surface then extends along first level 5, as shown by 33e.

Second spiral conveyor 34 has a second conveying surface input, shown as 35a, at first level 4. Second spiral conveyor 34 then extends about support 20 of second spiral conveyor system 10 such that second conveying surface is configured to move upwardly on second spiral conveyor system 10, as shown by 35b, to second level 6. Second conveying surface then extends along second level 6, as shown by 35c. Second spiral conveyor 34 then extends about support 20 of first spiral conveyor system 10 such that second conveying surface is configured to move downwardly on first spiral conveyor system 10, as shown by 35d, to return to first level 4. An output of second conveying surface then extends along first level 4, as shown by 35e.

While first and second spiral conveyors 32, 34 are shown to move in opposing directions from respective first levels 4, 5 to respective second levels 6, 7 and back to respective first levels 4, 5, first and second spiral conveyors 32, 34 may be configured to move in similar directions to a variety of levels. For instance, first and second spiral conveyors 32, 34 may be configured to move from a second level 6, 7 to a first level 4, 5 and back to a second level 6, 7. First and second spiral conveyors 32, 34 may also be configured to move to additional or alternative levels above and/or below levels 4, 5, 6, 7.

### III. A Second Exemplary Multi-Directional Spiral Conveyor System

FIGS. 25-26 show a second exemplary multi-directional spiral conveyor system 200 that is similar to spiral conveyor system 10, except that spiral conveyor system 200 includes an additional third spiral conveyor 236. As shown, spiral conveyor system 200 comprises a conveyor assembly 230 coupled with support 220. Conveyor assembly 230 includes a first spiral conveyor 232 defining a first conveying surface 233 configured to transport a plurality of articles 8 thereon, a second spiral conveyor 234 defining a second conveying surface 235 configured to transport a plurality of articles 8 thereon, and a third spiral conveyor 236 defining a third conveying surface 237 configured to transport a plurality of articles 8 thereon. First, second, and third spiral conveyors 232, 234, 236 are positioned about support 20 in a triple helical configuration such that first, second, and third spiral conveyors 232, 234, 236 are interleaved in an alternating configuration about longitudinal axis A of support 20. Accordingly, conveyor system 200 is configured to provide an additional third spiral conveyor 236 to the double helical configuration of conveyor system 10 to form a triple helical configuration.

Each of first, second, and third conveying surfaces 233, 235, 237 are configured to selectively move in an inclining direction to transport the plurality of articles 8 upward and/or a declining direction to transport the plurality of articles 8 downward. Accordingly, spiral conveyor system 200 can be configured to operate in one or both of a multi-directional configuration and a multi-lane configuration. For instance, each of first, second, and third conveying surfaces 233, 235, 237 can be simultaneously moved in the same direction, either inclining or declining, such that spiral conveyor system 10 is operated in a multi-lane configuration. One of first, second, and third conveying surfaces 233, 235, 237 can be moved in an opposing direction relative to the other two conveying surfaces 233, 235, 237 such that spiral conveyor system 10 is operated in a multi-directional configuration. Still other suitable configurations for spiral conveyor system 200 will be apparent to one with ordinary skill in the art in view of the teachings herein.

### III. A Third Exemplary Multi-Directional Spiral Conveyor System

FIGS. 27-28 show a third exemplary multi-directional spiral conveyor system 300 that is similar to spiral conveyor system 10, except that spiral conveyor system 300 forms a non-circular configuration such as a semi-elliptical configuration. As shown, spiral conveyor system 300 comprises a conveyor assembly 330 coupled with support 320. While only one spiral conveyor is shown, conveyor assembly 330 can include two or more spiral conveyors that define a conveying surface configured to transport a plurality of articles 8 thereon. Such spiral conveyors can be positioned about support 320 in a generally helical configuration such that the spiral conveyors are interleaved in an alternating configuration about support 320. In the illustrated version, conveyor assembly 330 includes a pair of curved portions 340 and a pair of substantially straight portions 342 positioned between curved portions 340 to form a substantially elliptical shape. Accordingly, conveyor assembly 330 may be positioned about or around an obstacle 9, such as a building pillar, to optimize the position of conveyor assembly 330. Still other suitable configurations for conveyor assembly 330 can be used. For instance, one or more curved portions 340 and one or more straight portions 342 can be used to form any suitable non-circular shape of conveyor assembly 330.

Conveyor system 300 further comprises one or more radial conveyor sections 350 extending outwardly relative to conveyor assembly 330 such that radial conveyor sections 350 are oriented substantially perpendicularly relative to conveyor assembly 330. Accordingly, radial conveyor sections 350 are configured to transfer articles conveyed on conveyor system 300 into and/or out of conveyor assembly 330. In the illustrated version, a respective transfer device 352 is positioned at an intersection between each radial conveyor section 350 and conveyor assembly 330. Each transfer device 352 is configured to transfer an article between each radial conveyor section 350 and conveyor assembly 330 to change the direction of the article between each radial conveyor section 350 and conveyor assembly 330. For instance, transfer device 352 can be a pop-up lateral belt transfer device. Still other suitable configurations for transfer device 352 can be used.

### IV. Examples

The following examples relate to various non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. For example, each of the conveying surfaces may be operated at any desired speed, continuously or intermittingly. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### EXAMPLE 1

A spiral conveyor system configured to transport a plurality of articles thereon between at least one first level and at least one second level having a different elevation than the at least one first level, wherein the spiral conveyor system comprises: a support extending generally vertically between the at least one first level and the at least one second level, wherein the support defines a longitudinal axis; and a conveyor assembly coupled with the support, wherein the conveyor assembly comprises: a first spiral conveyor defining a first conveying surface configured to transport the plurality of articles thereon, and a second spiral conveyor defining a second conveying surface configured to transport the plurality of articles thereon, wherein the second conveying surface is independently operable relative to the first conveying surface, wherein the first and second spiral conveyors are positioned around the support in a double helical configuration such that the first and second spiral conveyors are interleaved in an alternating configuration about the longitudinal axis of the support between the at least one first level and the at least one second level.

### EXAMPLE 2

The spiral conveyor system of example 1, wherein each of the first and second conveying surfaces are respectively configured to selectively move in an inclining direction and in a declining direction, wherein the first and second conveying surfaces are respectively configured to move upwardly from a lower elevation to a higher elevation in the inclining direction, and wherein the first and second conveying surfaces are respectively configured to move downwardly from a higher elevation to a lower elevation in the declining direction.

### EXAMPLE 3

The spiral conveyor system of example 2, wherein the first and second conveying surfaces are configured to move in opposing directions when the spiral conveyor system is in a multi-directional configuration.

### EXAMPLE 4

The spiral conveyor system of example 2, wherein the first and second conveying surfaces are configured to move in the same direction when the spiral conveyor system is in a multi-lane configuration.

### EXAMPLE 5

The spiral conveyor system of any of examples 1 through 4, wherein the support comprises a plurality of arms extending outward from the support and coupled to the conveyor assembly to support the conveyor assembly.

### EXAMPLE 6

The spiral conveyor system of example 5, wherein each arm is longitudinally and rotationally offset relative to an adjacent arm relative to the longitudinal axis of the support.

### EXAMPLE 7

The spiral conveyor system of either example 5 or 6, wherein each arm is coupled to the support at a select height along the support.

### EXAMPLE 8

The spiral conveyor system of any of examples 1 through 7, wherein each of the first and second spiral conveyors respectively comprise a pair of side walls and a plurality of rollers extending between the side walls, wherein each roller of the plurality of rollers respectively defines the first and second conveying surfaces.

### EXAMPLE 9

The spiral conveyor system of example 8, wherein each roller is tapered from a first end to a second end.

### EXAMPLE 10

The spiral conveyor system of either of examples 8 or 9, wherein the plurality of rollers are interconnected via at least one O-band, wherein at least one roller of the plurality of rollers is coupled with a motor such that the motor is configured to drive the plurality of rollers.

### EXAMPLE 11

The spiral conveyor system of any of examples 1 through 11, wherein the first spiral conveyor defines a first rise, wherein the second spiral conveyor defines a second rise.

### EXAMPLE 12

The spiral conveyor system of example 11, wherein the first rise is substantially equal to the second rise.

### EXAMPLE 13

The spiral conveyor system of any of examples 1 through 12, wherein the first conveying surface includes a first input and a first output, wherein the second conveying surface includes a second input and a second output, wherein each of the first and second inputs and each of the first and second outputs are respectively positioned at a select angular direction relative to the longitudinal axis of the support.

### EXAMPLE 14

A conveyor system configured to transport a plurality of articles thereon, wherein the conveyor system includes more than one spiral conveyor system of any of the examples 1 through 13.

### EXAMPLE 15

The spiral conveyor system of any of examples 1 through 14, wherein the conveyor assembly further comprises a third spiral conveyor defining a third conveying surface configured to transport the plurality of articles thereon, wherein the third conveying surface is independently operable relative to both the first and second conveying surfaces, wherein the first, second, and third spiral conveyors are positioned about the support in a triple helical configuration such that the first, second, and third spiral conveyors are interleaved in an alternating configuration about the longitudinal axis of the support between the at least one first level and the at least one second level.

### EXAMPLE 16

The spiral conveyor system of any of examples 1 through 15, wherein each of the first and second spiral conveyors include one or more curved portions and one or more straight portions to form a quasi-helical shape.

### EXAMPLE 17

The spiral conveyor system of any of examples 1 through 16 further comprising one or more radial conveyor sections extending substantially perpendicular relative to the first and second spiral conveyors such that the plurality of articles can be transferred between the one or more radial conveyor sections and the first and second spiral conveyors.

### EXAMPLE 18

A spiral conveyor system configured to transport a plurality of articles thereon between at least one first level and at least one second level having a different elevation than the at least one first level, wherein the spiral conveyor system comprises: a support extending generally vertically at least between the at least one first level and the at least one second level, wherein the support defines a longitudinal axis; and a conveyor assembly comprising a plurality of spiral conveyors, wherein each spiral conveyor of the plurality of spiral conveyors defines a conveying surface configured to transport the plurality of articles thereon, wherein each spiral conveyor is coupled with the support in a helical configuration such that each spiral conveyor is interleaved in an alternating configuration with at least one other spiral conveyor of the plurality of spiral conveyors of the conveyor assembly about the longitudinal axis of the support between the at least one first level and the at least one second level.

### EXAMPLE 19

The spiral conveyor system of example 18, wherein the conveying surface of each spiral conveyor of the plurality of spiral conveyors is configured to selectively move in an inclining direction or in a declining direction, wherein the conveying surface is configured to move upwardly from a lower elevation to a higher elevation in the inclining direction, and wherein the conveying surface is configured to move downwardly from a higher elevation to a lower elevation in the declining direction.

### EXAMPLE 20

A spiral conveyor system configured to transport a plurality of articles thereon, wherein the spiral conveyor system comprises: a support extending generally vertically, wherein the support defines a longitudinal axis; and a conveyor assembly coupled with the support, wherein the conveyor assembly comprises: a first spiral conveyor defining a first conveying, wherein the first conveying surface is configured to move in a select one of an inclining direction and a declining direction between a respective first and second elevation of the first spiral conveyor, and a second spiral conveyor defining a second conveying surface, wherein the second conveying surface is independently operable from the first conveying surface, wherein the second conveying surface is configured to move in a select one of an inclining direction and a declining direction between a respective first and second elevation of the second spiral conveyor, wherein the spiral conveyor system is configured to operate in a select one of a multi-directional configuration and a multi-lane configuration, wherein the first conveying surface is configured to move in an opposing inclining or declining direction relative to the second conveying surface when the spiral conveyor system is in the multi-directional configuration, and wherein the first conveying surface is configured to move in the same inclining or declining direction as the second conveying surface when the spiral conveyor system is in the multi-lane configuration.

Having shown and described various embodiments of the present innovation, further adaptations of the methods and systems described herein may be accomplished by appropriate modifications by one of ordinary skill in the art without departing from the scope of the present innovation. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present innovation should be considered in terms of the following claims and is understood not to be limited to the details of structure and operation shown and described in the specification and drawings.

What is claimed is:

1. A spiral conveyor system configured to transport a plurality of articles thereon between at least one first level and at least one second level having a different elevation than the at least one first level, wherein the spiral conveyor system comprises:
(a) a support extending generally vertically at least between the at least one first level and the at least one second level, wherein the support defines a longitudinal axis; and
(b) a conveyor assembly coupled with the support, wherein the conveyor assembly comprises:
(i) a first spiral conveyor defining a first conveying surface, and
(ii) a second spiral conveyor defining a second conveying surface, wherein the second conveying surface is independently operable relative to the first conveying surface,
wherein the first and second spiral conveyors are positioned around the support in a double helical configuration such that the first and second spiral conveyors are interleaved in an alternating configuration about the longitudinal axis of the support between the at least one first level and the at least one second level.

2. The spiral conveyor system of claim 1, wherein each of the first and second conveying surfaces are respectively configured to selectively move in an inclining direction and in a declining direction, wherein the first and second conveying surfaces are respectively configured to move upwardly from a lower elevation to a higher elevation in the inclining direction, and wherein the first and second conveying surfaces are respectively configured to move downwardly from a higher elevation to a lower elevation in the declining direction.

3. The spiral conveyor system of claim 2, wherein the first and second conveying surfaces are configured to move in opposing inclining and declining directions when the spiral conveyor system is in a multi-directional configuration.

4. The spiral conveyor system of claim 2, wherein the first and second conveying surfaces are configured to move in the same inclining and declining direction when the spiral conveyor system is in a multi-lane configuration.

5. The spiral conveyor system of claim 1, wherein the support comprises a plurality of arms extending outward from the support and coupled to the conveyor assembly to support the conveyor assembly.

6. The spiral conveyor system of claim 5, wherein each arm is longitudinally and rotationally offset relative to an adjacent arm relative to the longitudinal axis of the support.

7. The spiral conveyor system of claim 5, wherein each arm is coupled to the support at a select height along the support.

8. The spiral conveyor system of claim 1, wherein each of the first and second spiral conveyors respectively comprise a pair of side walls and a plurality of rollers extending between the side walls, wherein the plurality of roller are rotatable relative to the side walls, wherein each roller of the plurality of rollers respectively defines the first and second conveying surfaces.

9. The spiral conveyor system of claim 8, wherein each roller is tapered from a first end to a second end.

10. The spiral conveyor system of claim 8, wherein the plurality of rollers are interconnected via at least one O-band, wherein at least one roller of the plurality of rollers is coupled with a motor such that the motor is configured to drive the plurality of rollers.

11. The spiral conveyor system of claim 1, wherein the first spiral conveyor defines a first rise, wherein the second spiral conveyor defines a second rise.

12. The spiral conveyor system of claim 11, wherein the first rise is substantially equal to the second rise.

13. The spiral conveyor system of claim 1, wherein the first conveying surface includes a first input and a first output, wherein the second conveying surface includes a second input and a second output, wherein each of the first and second inputs and each of the first and second outputs are respectively positioned at a select angular direction relative to the longitudinal axis of the support.

14. A conveyor system configured to transport a plurality of articles thereon, wherein the conveyor system includes more than one spiral conveyor system of claim 1.

15. The spiral conveyor system of claim 1, wherein the conveyor assembly further comprises a third spiral conveyor defining a third conveying surface configured to transport the plurality of articles thereon, wherein the third conveying surface is independently operable relative to both the first and second conveying surfaces, wherein the first, second, and third spiral conveyors are positioned about the support in a triple helical configuration such that the first, second, and third spiral conveyors are interleaved in an alternating configuration about the longitudinal axis of the support between the at least one first level and the at least one second level.

16. The spiral conveyor system of claim 1, wherein each of the first and second spiral conveyors include one or more curved portions and one or more straight portions to form a non-circular shape.

17. The spiral conveyor system of claim 1 further comprising one or more radial conveyor sections extending substantially perpendicular relative to the first and second spiral conveyors such that the plurality of articles can be transferred between the one or more radial conveyor sections and the first and second spiral conveyors.

18. A spiral conveyor system configured to transport a plurality of articles thereon between at least one first level and at least one second level having a different elevation than the at least one first level, wherein the spiral conveyor system comprises:
(a) a support extending generally vertically at least between the at least one first level and the at least one second level, wherein the support defines a longitudinal axis; and
(b) a conveyor assembly comprising a plurality of spiral conveyors, wherein each spiral conveyor of the plurality of spiral conveyors defines a conveying surface configured to transport the plurality of articles thereon, wherein each spiral conveyor is coupled with the support in a helical configuration such that each spiral conveyor is interleaved in an alternating configuration with at least one other spiral conveyor of the plurality of spiral conveyors of the conveyor assembly about the longitudinal axis of the support between the at least one first level and the at least one second level.

19. The spiral conveyor system of claim 18, wherein the conveying surface of each spiral conveyor of the plurality of spiral conveyors is configured to selectively move in an inclining direction or in a declining direction, wherein the conveying surface is configured to move upwardly from a lower elevation to a higher elevation in the inclining direction, and wherein the conveying surface is configured to move downwardly from a higher elevation to a lower elevation in the declining direction.

20. A spiral conveyor system configured to transport a plurality of articles thereon, wherein the spiral conveyor system comprises:
(a) a support extending generally vertically, wherein the support defines a longitudinal axis; and
(b) a conveyor assembly coupled with the support, wherein the conveyor assembly comprises:
(i) a first spiral conveyor defining a first conveying surface, wherein the first conveying surface is configured to move in a select one of an inclining direction and a declining direction between a respective first and second elevation of the first spiral conveyor, and
(ii) a second spiral conveyor defining a second conveying surface, wherein the second conveying surface is independently operable from the first conveying surface, wherein the second conveying surface is configured to move in a select one of an inclining direction and a declining direction between a respective first and second elevation of the second spiral conveyor,
wherein the spiral conveyor system is configured to operate in a select one of a multi-directional configuration and a multi-lane configuration, wherein the first conveying surface is configured to move in an opposing inclining or declining direction relative to the second conveying surface when the spiral conveyor system is in the multi-directional configuration, and wherein the first conveying surface is configured to move in the same inclining or declining direction as the second conveying surface when the spiral conveyor system is in the multi-lane configuration.
